(19) United States
(12) Patent Application Publication
(10) Pub. No.: US 2011/0200279 A1
(43) Pub. Date: Aug. 18, 2011

(54) ROTARY DEVICE

(75) Inventor: Hiromitsu GOTO, Shizuoka (JP)

(73) Assignee: ALPHANA TECHNOLOGY CO., LTD., Shizuoka (JP)

(21) Appl. No.: 12/979,700

(22) Filed: Dec. 28, 2010

(30) Foreign Application Priority Data
Feb. 12, 2010 (JP) 2010-029168

(51) Int. Cl. F16C 32/06

(52) U.S. Cl. 384/107

(57) ABSTRACT

A rotary device according to an aspect of the invention includes: a sleeve having an inner cylindrical surface, a first end portion and a second end portion at respective ends of the inner cylindrical surface; a shaft that is accommodated in the inner cylindrical surface in a manner rotatable relative to the inner cylindrical surface; a fluid present in a space between the shaft and the sleeve; a first pump portion formed in a middle portion of the inner cylindrical surface and configured to cause the fluid to flow toward the first end portion by the relative rotation of the shaft and the sleeve; a first radial narrow gap formed at a region of the inner cylindrical surface on a side of the first end portion with respect to the first pump portion; and a first circulation path communicated with the first pump portion.

### CROSS-REFERENCE TO RELATED APPLICATION

This application is based on Japanese Patent Application No. 2010-029168 filed with the Japan Patent Office on Feb. 12, 2010, the entire content of which is hereby incorporated by reference.

### BACKGROUND

1. Technical Field

The invention relates to a rotary device such as a disk drive device, and more particularly, to a rotary device such as a disk drive device capable of maintaining the stiffness of a bearing even with a thinner structure.

2. Related Art

In recent years, some rotary devices such as disk drive devices as typified by hard disk drives (HDDs) have fluid dynamic bearing units mounted thereon. In such a fluid dynamic bearing unit, a space between a sleeve constituting a part of a stator and a shaft constituting a part of a rotor is filled with a lubricating fluid, for example. The fluid dynamic bearing unit supports the rotor in a non-contact state by dynamic pressure generated in a portion of the lubricating fluid. Accordingly, a smooth and high speed rotation of the rotor is realized (refer, for example, to JP-A-2007-198555).

### SUMMARY

There has been a demand for reducing the size in the axial direction of the rotary devices such as disk drive devices and improving the stiffness of bearings so as to prevent degradation in impact resistance. If the size in the axial direction of a rotary device such as a disk drive device is reduced, the distance between supporting points of a bearing in the radial direction of a bearing unit becomes shorter. Accordingly, the stiffness of the bearing of the bearing unit is lowered. If the stiffness of the bearing of the bearing unit is lowered, this results in a larger displacement in the axial direction of a rotor including a recording disk when the rotary device such as a disk drive device is subjected to impact and vibrates. The larger displacement of the recording disk results in a concern that the frequency of errors in reading/writing data may be increased since a constant relative distance between the recording disk and a magnetic head cannot be maintained.

An object of an aspect of the invention is to provide a rotary device such as a disk drive device capable of increasing the distance between supporting points of a bearing in the radial direction of a bearing unit. If the distance between the supporting points of the bearing in the radial direction of the bearing unit is longer, the stiffness of the bearing can be maintained even when the rotary device is structured to be thinner. Accordingly, read/write operations can be performed stably even in an environment with much vibration.

A rotary device according to an aspect of the invention includes: a sleeve having an inner cylindrical surface, a first end portion at an outer position in an axial direction of the inner cylindrical surface, and a second end portion that is an end portion opposite to the first end portion; a shaft that has at least a part thereof accommodated in the inner cylindrical surface and that is rotatable relative to the inner cylindrical surface; a fluid present at least in a space between the shaft and the sleeve; a first pump portion formed in a middle portion in the axial direction of the inner cylindrical surface and configured to generate a first flow of the fluid in a direction toward the first end portion by the relative rotation of the shaft and the sleeve; a first radial narrow gap formed at a region of the inner cylindrical surface on a side of the first end portion with respect to the first pump portion; and a first circulation path connected to the first end portion of the sleeve and communicated with the first pump portion.

According to the aspect, the first radial narrow gap is a supporting point of a bearing in the radial direction of a bearing unit including the shaft and the sleeve. The first radial narrow gap is formed at the inner cylindrical surface of the sleeve outside of the first pump portion. Accordingly, it is possible to provide a supporting point of the bearing at a position nearer to an end portion of the bearing unit. Accordingly, it is possible to increase the distance between the supporting points of the bearing in the radial direction of the bearing unit. As a result, the stiffness of the bearing can be maintained even when the rotary device is structured to be thinner. Thus, it is possible to provide a rotary device such as a disk drive device capable of performing read/write operations stably even in an environment with much vibration.

According to this aspect, it is possible to increase the distance between the supporting points of the bearing in the radial direction of the bearing unit. Accordingly, the stiffness of the bearing can be maintained even when the rotary device is structured to be thinner. Thus, it is possible to provide a rotary device such as a disk drive device capable of performing read/write operations stably even in an environment with much vibration.

### BRIEF DESCRIPTION OF THE DRAWINGS

The foregoing and other objects, features, aspects and advantages of the invention will become more apparent from the following detailed description when taken in conjunction with the accompanying drawings, in which:

FIG. 1 is an explanatory view for explaining an internal structure of an HDD that is an example of a rotary device according to an embodiment;

FIG. 2 is a schematic cross sectional view of a brushless motor in the rotary device according to the embodiment;

FIG. 3 is an enlarged cross sectional view of a main part of the brushless motor of FIG. 2; and

FIG. 4 is an explanatory view for explaining basic shapes of first pumping grooves and second pumping grooves in a first pump portion and a second pump portion of the rotary device according to the embodiment.

### DESCRIPTION OF EMBODIMENTS

Preferred embodiments of the present invention will be described below with reference to the accompanying drawings, in which like reference characters designate similar or identical parts throughout the several views thereof.

An embodiment according to an aspect of the invention will now be described with reference to the drawings. A hard disk drive (HDD) according to the embodiment is an example of a rotary device according to an aspect of the invention.

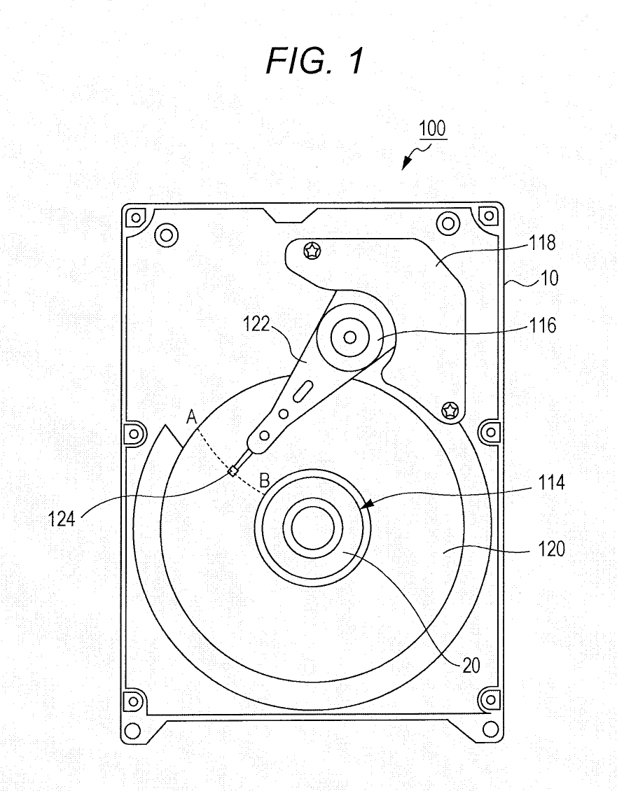

FIG. 1 is an explanatory view for explaining an internal structure of the HDD 100 (hereinafter referred to as a rotary device 100) according to the embodiment. FIG. 1 shows a state in which a cover is removed so as to expose the internal structure.

A brushless motor 114, an arm bearing unit 116, a voice coil motor 118 and the like are mounted on an upper surface of a base member 10. The brushless motor 114 supports, on a rotational axis, a hub 20 for mounting a recording disk 120 to rotationally drive the recording disk 120 that can magnetically record data, for example. The brushless motor 114 may be a spindle motor. The brushless motor 114 is driven by three-phase drive currents of U-phase, V-phase and W-phase. A magnetic head 124 moves with a swing of a swing arm 122 within a movable range A-B over the surface of the recording disk 120 with a slight space therebetween. With the movement, the magnetic head 124 reads/writes data from/to the recording disk 120.

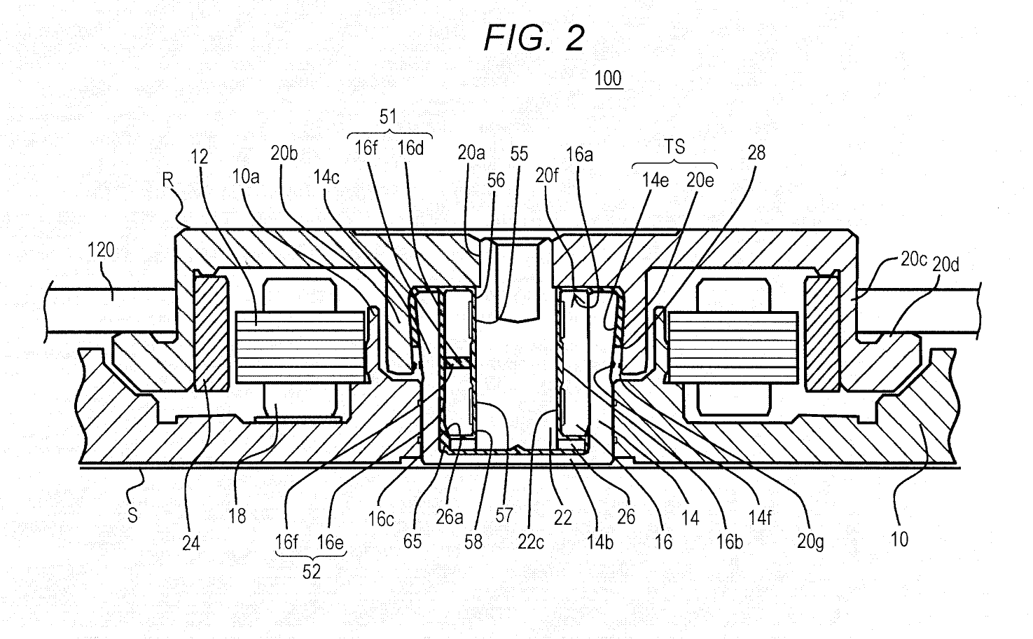

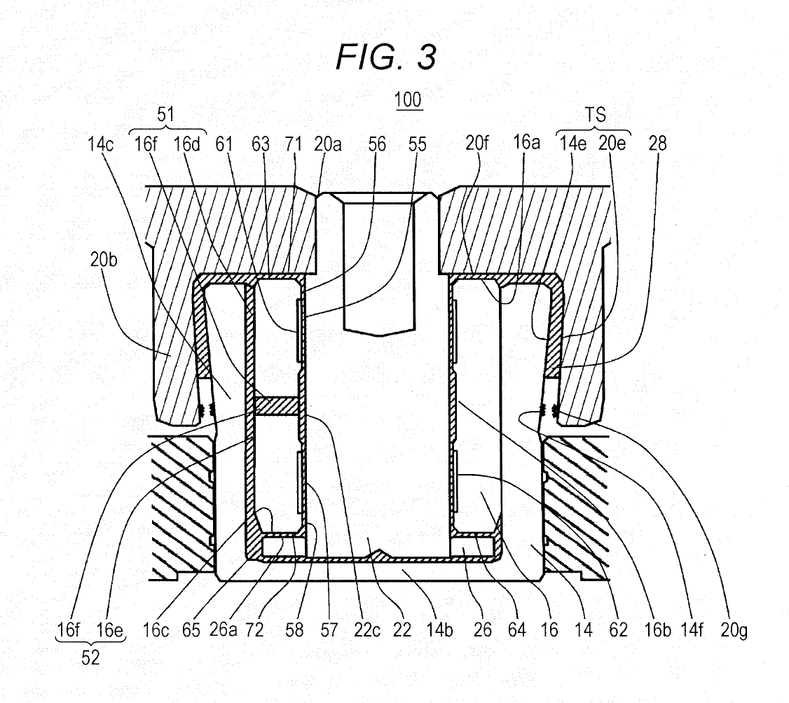

FIG. 2 is a schematic cross sectional view of the brushless motor of the rotary device 100 according to the embodiment taken along the axial direction of a shaft 22. FIG. 3 is an enlarged cross sectional view of a main part of the brushless motor of FIG. 2. The rotary device 100 includes a stator S and a rotor R. The stator S includes the base member 10, a stator core 12, a housing 14, and a sleeve 16. The rotor R includes the hub 20, the shaft 22, and a flange 26. The base member 10 includes a cylindrical portion 10a. The housing 14 includes a bottom portion 14b and a cylindrical portion 14c. The sleeve 16 includes an inner cylindrical surface 16b, a first end portion 16a and a second end portion 16c. A coil 18 is wound around the stator core 12. The hub 20 includes a central opening 20a, a first cylindrical portion 20b, a second cylindrical portion 20c, and a hub extension portion 20d. The shaft 22 includes a stepped portion, an end portion and an outer cylindrical surface 22c. Throughout the following description, a lower side and an upper side in FIGS. 2 and 3 will be expressed as “lower” and “upper”, respectively, for convenience of explanation.

The base member 10 has an opening at a central portion thereof and the cylindrical portion 10a surrounding the opening at the central portion. The base member 10 holds the housing 14 in the opening at the central portion. The stator core 12 is fixed on an outer circumferential side of the cylindrical portion 10a surrounding the housing 14. The base member 10 is formed by cutting an aluminum die casting, by pressing an aluminum plate or by pressing an iron plate and plating the pressed plate with nickel.

The stator core 12 is formed by laminating a magnetic material such as a silicon steel plate and then applying insulation coating onto the surface of the laminated body by electrodeposition coating, powder coating or the like. The stator core 12 has a ring shape with a plurality of salient poles (not shown) projecting outward. The coil 18 is wound around each salient pole. The number of the salient poles is nine when the rotary device 100 such as a disk drive device is of a three-phase drive type. Winding terminals of the coil 18 are soldered on a flexible printed circuit (FPC) board arranged on a bottom surface of the base member 10. The winding terminals that are drawn out are fixed by an adhesive so that the coil 18 does not loosen. When three-phase currents having a substantially sine waveform are applied to the coil 18 through the FPC by a predetermined drive circuit, the coil 18 generates a rotating magnetic field around the salient poles of the stator core 12. Then, a rotational driving force is generated by interaction between the driving magnetic poles of a magnet 24 and the rotating magnetic field. The rotational driving force rotates the rotor R.

The rotary device 100 of FIG. 2 further includes the housing 14 having a bottomed cup shape. The housing 14 accommodates at least a part of the sleeve 16. The housing 14 is fixed on an inner circumferential surface of the cylindrical portion 10a by adhesion or press fitting. The housing 14 has a substantially cup shape in which the cylindrical portion 14c surrounding the sleeve 16 and the bottom portion 14b sealing a lower end portion of the cylindrical portion 14c are connected. The bottom portion 14b of the housing 14 having such a shape is opposed to the second end portion 16c of the sleeve 16 in the axial direction. The bottom portion 14b and the cylindrical portion 14c may be formed integrally. Alternatively, the bottom portion 14b and the cylindrical portion 14c may be formed using separate members and then fixed to each other. The housing 14 may be formed of a copper alloy, a sintered alloy produced by powder metallurgy, a stainless steel, or a plastic material such as polyetherimide, polyimide and polyamide. If the housing 14 is formed of a plastic material, it is preferable that a carbon fiber or the like be contained in the plastic material so that the specific resistance of the housing 14 is 10⁶ Ω·m or less. This is to ensure the static eliminating performance of the rotary device 100 such as a disk drive device.

The sleeve 16 is formed to have a substantially cylindrical shape. The sleeve 16 is fixed to an inner circumferential surface of the housing 14 by adhesion or press fitting so that the sleeve 16 is fixed coaxially with the opening at the central portion of the base member 10. The sleeve 16 has the annular inner cylindrical surface 16b inside thereof that accommodates the shaft 22 to support the shaft 22. The sleeve 16 has the inner cylindrical surface 16b, the first end portion 16a on the hub 20 side of the inner cylindrical surface 16b, and the second end portion 16c opposite to the first end portion 16a with respect to the inner cylindrical surface 16b. The inner cylindrical surface 16b surrounds the outer cylindrical surface 22c of the shaft 22. A radial space is defined between the inner cylindrical surface 16b of the sleeve 16 and the outer cylindrical surface 22c of the shaft 22.

The sleeve 16 may be formed of a copper alloy, a sintered alloy produced by powder metallurgy, or a stainless steel. Alternatively, the sleeve 16 may be formed of a plastic material such as polyetherimide, polyimide and polyamide. If the sleeve 16 is formed of a plastic material, it is preferable that a carbon fiber or the like be contained in the plastic material so that the specific resistance of the sleeve 16 is 10⁶ Ω·m or less. This is to ensure the static eliminating performance of the rotary device 100 such as a disk drive device. The first end portion 16a and the second end portion 16c may be formed integrally with the sleeve 16. Alternatively, the first end portion 16a and the second end portion 16c may be formed using separate members and then fixed to form the sleeve 16.

The hub 20 includes the central opening 20a formed at the central portion thereof, the first cylindrical portion 20b surrounding the central opening 20a, the second cylindrical portion 20c arranged outside of the first cylindrical portion 20b, and the hub extension portion 20d that extends outward in the radial direction of the hub 20 at the lower end of the second cylindrical portion 20c. The hub 20 has a substantially cup shape. The hub 20 is soft magnetic. Examples of the material for the hub 20 include a steel material such as SUS430F. The hub 20 is formed by pressing or cutting a steel plate into a predetermined substantially cup shape. For example, a stainless steel with the trade name DHS1 supplied by Daido Steel Co., Ltd. is preferable as the material for the hub 20 in that DHS1 has a low outgassing property and can be processed easily. Similarly, a stainless steel with the trade name DHS2 is more preferable as the material for the hub 20 in that DHS2 has a good corrosion resistance. The hub 20 may be formed of a combination of a nonmagnetic aluminum member and a magnetic iron member. This structure is advantageous in that the weight of the rotary device 100 can be reduced.

The magnet 24 is fixed to the inner circumferential surface of the second cylindrical portion 20c of the hub 20. The magnet 24 is fixed to an annular portion concentric with the shaft 22 so as to be opposed to the stator core 12 fixed to the base member 10. This structure allows the hub 20 to rotate integrally with the shaft 22 to drive the recording disk 120, which is not shown. The recording disk 120 is mounted on the hub extension portion 20d in a state in which the central opening of the recording disk 120 is engaged with an outer circumferential surface of the second cylindrical portion 20c.

The shaft 22 is fixed to the central opening 20a of the hub 20. The shaft 22 has a stepped portion at the upper end thereof. In assembly, the shaft 22 is press fitted in the central opening 20a. As a result, the movement of the hub 20 in the axial direction is restricted by the stepped portion, and the hub 20 is integrated with the shaft 22 with a predetermined squareness. The lower end portion side of the shaft 22 is accommodated in the inner cylindrical surface 16b of the sleeve 16. The shaft 22 may be formed of a stainless steel material, for example.

In the rotary device 100 of FIG. 2 according to the embodiment, the flange 26 is formed in a predetermined substantially disc shape. The central opening formed at the central portion of the flange 26 is fixed to the end of the shaft 22 on the base member 10 side by close fitting or adhesion.

In the rotary device 100 of FIG. 2 according to the embodiment, a flange accommodating region 65 is formed in a space in the axial direction between the bottom portion 14b and the second end portion 16c. The flange 26 is rotatably accommodated in the flange accommodating region 65. The flange 26 rotates integrally with the shaft 22.

If the rotor R and the stator S move relatively to each other due to an impact, the flange 26 comes in contact with the lower surface of the second end portion 16c. Thus, the flange 26 also has a function of preventing separation of the rotor R from the stator S.

The flange 26 may be formed of a copper alloy, a sintered alloy produced by powder metallurgy, a stainless steel or the like. The flange 26 can be easily produced at a low cost by pressing a plate metal material, for example. Press working or the like also allows a small and thin flange 26 to be formed with high dimensional accuracy. This can contribute to miniaturization and reduction in weight of the rotary device 100 such as a disk drive device. The flange 26 may be formed of a material having a coefficient of linear expansion substantially equal to that of the material for forming the shaft 22. This is advantageous in that the variation in the space between the flange 26 and the shaft 22 fixed to each other can be suppressed even under temperature change.

The flange 26 may alternatively be formed of a plastic material such as polyetherimide, polyimide and polyamide. If the flange 26 is formed of a plastic material, it is preferable that a carbon fiber or the like be contained in the plastic material so that the specific resistance of the flange 26 is 10⁶ Ω·m or less. This is to ensure the static eliminating performance of the rotary device 100 such as a disk drive device.

The magnet 24 is fixed to the inner circumference of the second cylindrical portion 20c. The magnet 24 is arranged so as to be opposed to the stator core 12 with a small space between the magnet 24 and the outer circumference of the stator core 12. The magnet 24 is formed of a Nd—Fe—B (neodymium-iron-boron)-based material. The surface of the magnet 24 is applied with electrodeposition coating or spray coating. The inner circumference of the magnet 24 is magnetized to form twelve poles.

Next, a bearing in the radial direction in the structure of the rotary device 100 will be described. The bearing in the radial direction includes the outer cylindrical surface 22c of the shaft 22, the inner cylindrical surface 16b of the sleeve 16 and a lubricating fluid 28 such as oil filling a space therebetween. The bearing in the radial direction has arranged therein the outer cylindrical surface 22c, the inner cylindrical surface 16b, a first pump portion 55 that generates a first flow of the lubricating fluid 28 toward the first end portion 16a in the space between the outer cylindrical surface 22c and the inner cylindrical surface 16b, and a first radial narrow gap 56 formed in a region nearer to the first end portion 16a with respect to the first pump portion 55.

Further, the rotary device 100 of FIG. 2 according to the embodiment has arranged therein the outer cylindrical surface 22c, the inner cylindrical surface 16b, a second pump portion 57 that generates a second flow of the lubricating fluid 28 toward the second end portion 16c in the space between the outer cylindrical surface 22c and the inner cylindrical surface 16c below the first pump portion 55, and a second radial narrow gap 58 formed in a region nearer to the second end portion 16c with respect to the second pump portion 57.

Next, the first pump portion 55 and the second pump portion 57 will be described. The first pump portion 55 and the second pump portion 57 may have basically the same shape. Therefore, the first and second pump portions may be described collectively as pump portions.

A structure in which the pump portions are adapted to rotate a shaft that has a number of projections serving as blades may be conceived. However, it requires much work to provide a number of projections on the shaft arranged in a small space. In contrast, the first pump portion 55 can include first pumping grooves 61 formed in stripes in at least one of the outer cylindrical surface 22c of the shaft 22 and the inner cylindrical surface 16b. Similarly, the second pump portion 57 can include second pumping grooves 62 formed in stripes in at least one of the outer cylindrical surface 22c and the inner cylindrical surface 16b.

The pump portions have the first pumping grooves 61 and the second pumping grooves 62 in at least one of the outer cylindrical surface 22c and the inner cylindrical surface 16b that are opposed to each other. The pumping grooves generate dynamic pressure to generate the flows of the lubricating fluid 28 toward the end portions. The first pumping grooves 61 and the second pumping grooves 62 may have basically the same shape. Therefore, the first and second pumping grooves may be described collectively as pumping grooves. The rotary device 100 of FIG. 2 according to the embodiment has the first pumping grooves 61 and the second pumping grooves 62 formed in the surfaces opposed to each other in the radial direction as dynamic pressure grooves for generating dynamic pressure in the lubricating fluid 28. On the other hand, the rotary device 100 does not have any dynamic pressure grooves in the surfaces opposed in the axial direction.

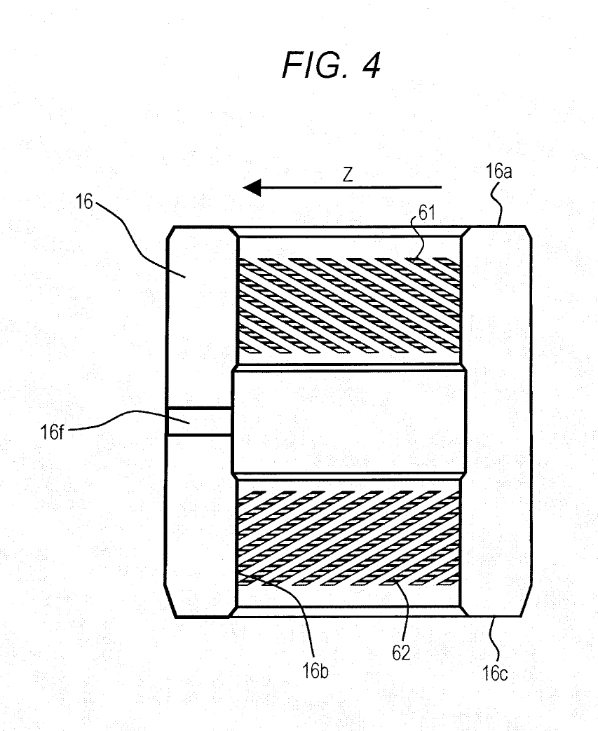

FIG. 4 is an explanatory view for explaining basic shapes of the first pumping grooves 61 and the second pumping grooves 62 formed in the inner cylindrical surface 16b of the sleeve 16 of the rotary device 100 according to the embodiment. The hatched regions in FIG. 4 represent the pumping grooves that are concave outward in the radial direction. As shown in FIG. 4, the first pumping grooves 61 and the second pumping grooves 62 include a plurality of concave pumping grooves regularly arranged along the circumferential direction Z of the sleeve 16. Thus, the first pumping grooves 61 and the second pumping grooves 62 include a plurality of concave pumping grooves that are inclined with respect to the rotational axis and regularly arranged in stripes along the rotating direction. The direction of inclination of the first pumping grooves 61 with respect to the rotational axis is opposite to the direction of inclination of the second pumping grooves 62 with respect to the rotational axis.

When the outer cylindrical surface 22c moves in the circumferential direction Z (leftward in FIG. 4) relative to the inner cylindrical surface 16b, the lubricating fluid 28 present between the inner cylindrical surface 16b and the outer cylindrical surface 22c also starts moving in the circumferential direction Z. At this time, the first flow that is upward in FIG. 4 along the first pumping grooves 61 is generated in the lubricating fluid 28. Similarly, the second flow that is downward in FIG. 4 along the second pumping grooves 62 is generated in the lubricating fluid 28.

The shape of the pumping grooves can be empirically determined using the number, depth, width, length in the axial direction and inclination angle with respect to the rotational axis of the grooves, the diameter of the pump portions and the viscosity of the lubricating fluid 28 as parameters.

The first pumping grooves 61 and the second pumping grooves 62 can be formed by performing mechanical processing such as cutting or rolling, chemical processing such as etching, or electrical processing utilizing electric discharge on the outer cylindrical surface 22c and the inner cylindrical surface 16b that are smoothed. For example, a method for forming the grooves by driving a cutting tool by a piezoelectric device is preferable in high accuracy of the width and the depth of the grooves and in producing less burrs and fins in processing.

Next, the first radial narrow gap 56 and the second radial narrow gap 58 will be described. The first and second radial narrow gaps are supporting points of the bearing in the radial direction of the bearing unit. The bearing unit is constituted by the housing 14 shown in FIG. 2 and the members arranged in the housing 14. Specifically, the bearing unit includes the housing 14, the sleeve 16, the shaft 22, the flange 26 and the lubricating fluid 28. The first radial narrow gap 56 and the second radial narrow gap 58 may have basically the same shape. Therefore, the first and second radial narrow gaps may be described collectively as radial narrow gaps.

The radial narrow gaps are formed in regions where the outer cylindrical surface 22c and the inner cylindrical surface 16b face each other in a small space between the outer cylindrical surface 22c and the inner cylindrical surface 16b. The rotation of the shaft 22 relative to the sleeve 16 causes the first pump portion 55 to push the lubricating fluid 28 toward the first end portion 16a. The first radial narrow gap 56 generates a first separating force in the radial direction between the outer cylindrical surface 22c and the inner cylindrical surface 16b in response to the pressure of the pushed lubricating fluid 28. Similarly, the second pump portion 57 pushes the lubricating fluid 28 toward the second end portion 16c. The second radial narrow gap 58 generates a second separating force in the radial direction between the outer cylindrical surface 22c and the inner cylindrical surface 16b in response to the pressure of the pushed lubricating fluid 28. As a result, the outer cylindrical surface 22c is supported so that the width of the space between the outer cylindrical surface 22c and the inner cylindrical surface 16b is constant along the circumferential direction inside the inner cylindrical surface 16b. Thus, when the shaft 22 and the sleeve 16 rotate relatively to each other, the radial narrow gaps support the shaft 22 in a non-contact state with a predetermined space in the radial direction between the shaft 22 and the sleeve 16. The first radial narrow gap 56 and the second radial narrow gap 58 are arranged in regions near the respective ends of the sleeve 16. Accordingly, it is possible to structure such that the distance between the supporting points of the bearing in the radial direction of the bearing unit is longer. As a result, it is possible to suppress reduction in the stiffness of the bearing of the bearing unit even when the rotary device such as a disk drive device is structured to be thinner. As a result, it is possible to suppress increase in the frequency of data read/write errors when the rotary device such as a disk drive device is subjected to impact and vibrates.

It may be conceived to form concaves and convexes on portions of the outer cylindrical surface 22c and the inner cylindrical surface 16b facing the first radial narrow gap 56 and the second radial narrow gap 58. However, it requires much work to form concaves and convexes, and the dimensional accuracy may be lowered. In contrast, it is also possible to form portions of the outer cylindrical surface 22c of the shaft 22 and the inner cylindrical surface 16b of the sleeve 16 at the region where the first radial narrow gap 56 is formed to be smoothed surfaces. Similarly, it is also possible to form portions of the outer cylindrical surface 22c of the shaft 22 and the inner cylindrical surface 16b of the sleeve 16 at the region where the second radial narrow gap 58 is formed to be smoothed surfaces. Thus, it is possible to flatten the portions of the outer cylindrical surface 22c and the inner cylindrical surface 16b facing the first radial narrow gap 56 and the second radial narrow gap 58. In this case, the radial narrow gaps are formed as spaces that have constant widths along the axial direction and the circumferential direction. In this case, it is possible to reduce the work for processing the shaft 22 and the sleeve 16 and to suppress reduction in the dimensional accuracy thereof.

The shape of the radial narrow gaps can be empirically determined using the diameter of the shaft 22, the width of the spaces in the diametrical direction of the pump portions, the length of the radial narrow gaps in the axial direction and the viscosity of the lubricating fluid 28 as parameters.

The inventors have confirmed by experiments that a good balance between the separating force in the radial direction and the reduction in drive currents can be obtained and a sufficient stiffness of the bearing can be ensured when the diameter of the shaft 22 is in the range of 2 to 5 mm, the width of the spaces in the diametrical direction of the pump portions is in the range of 2 to 20 μm, the number of pumping grooves is in the range of 6 to 40, the depth of the pumping grooves is in the range of 2 to 30 μm, the width of the pumping grooves is in the range of 0.1 to 2.0 mm, the length of the pumping grooves in the axial direction is in the range of 1 to 5 mm, the inclination angle of the pumping grooves with respect to the rotational axis is in the range of 10 to 60 degrees, the width of the spaces in the diametrical direction of the radial narrow gaps is in the range of 2 to 20 mm, the length of the radial narrow gaps in the axial direction is in the range of 0.2 to 3.0 mm, and the viscosity of the lubricating fluid 28 at 25° C. is in the range of 5 to 30 cst, as specific examples of the shape of the pumping grooves in the pump portions and the radial narrow gaps.

Next, a first thrust narrow gap 63 will be described. A structure in which the rotor R is supported in the axial direction using a plain bearing may be conceived. However, the plain bearing may have a short lifetime due to the effect of abrasion. Accordingly, the first thrust narrow gap 63 may be further provided at the first end portion 16a. In this case, the pressure of the lubricating fluid 28 present in the first thrust narrow gap 63 allows the rotor R to be supported in the axial direction in a non-contact state.

The rotary device 100 of FIG. 2 according to the embodiment further includes, on the lower surface of the hub 20, a first thrust portion 20f that extends outward in the radial direction of the shaft 22. The first thrust portion 20f rotates integrally with the shaft 22 relatively to the first end portion 16a. The first thrust narrow gap 63 can be formed in a region where the first thrust portion 20f and the first end portion 16a are opposed to each other along the axial direction.

The first end portion 16a and the first thrust portion 20f define a space open in the axial direction. The lubricating fluid 28 is present in the space. As the rotor R rotates and the pressure of the lubricating fluid 28 rises by the action of the first pump portion 55, the pressure of the lubricating fluid 28 present in the space between the first end portion 16a and the first thrust portion 20f also rises. Accordingly, a first separating force in the thrust direction is generated between the first end portion 16a and the first thrust portion 20f. As a result, the rotor R is supported in the axial direction in a state not in contact with the stator S in the first thrust narrow gap 63.

Next, a second thrust narrow gap 64 will be described. In order to determine the position of the rotor R in the axial direction with respect to the stator S, a force opposite to the first separating force in the thrust direction is typically caused to act on the rotor R. Accordingly, the forces acting on the rotor R are balanced. Thus, a structure in which another magnet is provided so that an attracting force acts on the rotor R may be conceived. However, this structure is disadvantageous in that the cost increases and the rotary device becomes larger by including the additional magnet. In contrast, the rotary device 100 of FIG. 2 according to the embodiment further includes a second thrust narrow gap 64 formed in an outer region in the radial direction of the inner cylindrical surface 16b of the second end portion 16c.

The rotary device 100 of FIG. 2 according to the embodiment further includes a second thrust portion 26a that extends outward in the radial direction of the shaft 22 and is substantially fixed to the shaft 22. The second thrust narrow gap 64 can be formed in a region where the second thrust portion 26a and the second end portion 16c are opposed to each other along the axial direction. In the rotary device 100, the second thrust portion 26a is formed integrally with the flange 26 at a portion of the flange 26 opposed to the second end portion 16c. The flange 26 will be described in detail later.

The second end portion 16c and the second thrust portion 26a define a space open in the axial direction. The lubricating fluid 28 is present in the space. As the rotor R rotates and the pressure of the lubricating fluid 28 rises by the action of the second pump portion 57, the pressure of the lubricating fluid 28 present in the space between the second end portion 16c and the second thrust portion 26a also rises. Accordingly, a second separating force in the thrust direction is generated between the second end portion 16c and the second thrust portion 26a. As a result, the rotor R is supported in the axial direction in a state not in contact with the stator S in the second thrust narrow gap 64.

The first separating force in the thrust direction and the second separating force in the thrust direction act on the rotor R in opposite directions. Accordingly, the rotor R becomes stable with respect to the stator S at a position where the separating forces are balanced. Thus, a stable stiffness of the rotor R in the axial direction with respect to the stator S can be ensured. As a result, it is possible to suppress increase in the cost and in the size of the rotary device.

Next, the shape of the first thrust narrow gap 63 and the second thrust narrow gap 64 will be described. The first thrust narrow gap 63 and the second thrust narrow gap 64 may have basically the same shape. Therefore, the first and second thrust narrow gaps may be described collectively as thrust narrow gaps.

It may be conceived to form concaves and convexes on the surfaces of the first end portion 16a and the first thrust portion 20f at the first thrust narrow gap 63. However, it requires much work to form concaves and convexes, and the dimensional accuracy may be lowered. In contrast, it is also possible to form portions of the first end portion 16a and the first thrust portion 20f at the region where the first thrust narrow gap 63 is formed to have smoothed surfaces. Similarly, it is also possible to form portions of the second end portion 16c and the second thrust portion 26a at the region where the second thrust narrow gap 64 is formed to have smoothed surfaces. It is also possible to flatten the surfaces of the first end portion 16a and the first thrust portion 20f facing the first thrust narrow gap 63 and the surfaces of the second end portion 16c and the second thrust portion 26a facing the second thrust narrow gap 64. In this case, the thrust narrow gaps are formed as spaces that have constant widths along the axial direction and the circumferential direction. Thus, grooves for generating dynamic pressure do not have to be formed in the first thrust narrow gap 63 and the second thrust narrow gap 64. As a result, it is possible to reduce the work for processing the members constituting the first end portion 16a, the first thrust portion 20f, the second end portion 16c and the second thrust portion 26a and to suppress reduction in the dimensional accuracy thereof.

The shape of the thrust narrow gaps can be empirically determined using the inner diameter and the outer diameter of the thrust narrow gaps, the width of the spaces of the thrust narrow gaps open in the axial direction, and the viscosity of the lubricating fluid 28 as parameters.

The inventors have confirmed by experiments that a good balance between the separating forces in the thrust direction and the reduction in drive currents can be obtained and a desired stiffness of the bearing can be ensured when the inner diameter of the thrust narrow gaps is in the range of 2.5 to 6.5 mm, the outer diameter of the thrust narrow gaps is in the range of 3.5 to 9.5 mm, the width of the spaces of the thrust narrow gaps open in the axial direction is in the range of 5 to 40 μm, and the viscosity of the lubricating fluid 28 at 25° C. is in the range of 5 to 30 cst, as specific examples of the shape of the thrust narrow gaps.

Next, a first circulation path 51 and a second circulation path 52 will be described. The first circulation path 51 and the second circulation path 52 may have basically the same shape. Therefore, the first and second circulation paths may be described collectively as circulation paths.

The first circulation path 51 and the second circulation path 52 may be holes formed through the sleeve 16. In addition, at least parts of the first circulation path 51 and the second circulation path 52 may be formed between the sleeve 16 and the housing 14. In the rotary device 100 of FIG. 2 according to the embodiment, grooves 16d and 16e extending in the axial direction are formed in the outer circumferential surface of the sleeve 16. The grooves 16d and 16e serve as paths communicating the first end portion 16a with the second end portion 16c at both end surfaces of the sleeve 16 between the sleeve 16 and the housing 14 after fitting the sleeve 16 into the cylindrical portion 14c. Thus, the first circulation path 51 and the second circulation path 52 can be provided separately. Alternatively, the first circulation path 51 and the second circulation path 52 may be formed so that a part of the first circulation path 51 is connected to a part of the second circulation path 52. Processing for forming grooves in the sleeve 16 is preferable to processing for forming holes along the axial direction in the sleeve 16 in that the former requires less work.

In the rotary device 100 of FIG. 2 according to the embodiment, a path 16f extending in the radial direction is formed in a middle portion of the sleeve 16. The path 16f is connected with the groove 16d to form the first circulation path 51. In addition, the path 16f is connected with the groove 16e to form the second circulation path 52. Thus, both the first circulation path 51 and the second circulation path 52 are structured to include the path 16f in common as parts thereof. This results in less work for processing the paths.

The lubricating fluid 28 pushed out from the upper portion of the first pump portion 55 circulates passing through the first radial narrow gap 56 and the first thrust narrow gap 63, then through the first circulation path 51, and being sucked into the lower portion of the first pump portion 55. Similarly, the lubricating fluid 28 pushed out from the lower portion of the second pump portion 57 circulates passing through the second radial narrow gap 58 and the second thrust narrow gap 64, then through the second circulation path 52, and being sucked into the upper portion of the second pump portion 57. The circulation of the lubricating fluid 28 contributes to the stability of the separating forces in the radial direction and the separating forces in the thrust direction generated in the radial narrow gaps and the thrust narrow gaps.

The shapes of the groove 16d, the groove 16e and the path 16f can be empirically determined using the cross-sectional shapes of the grooves and the paths, the numbers of the grooves and the paths, and the viscosity of the lubricating fluid 28 as parameters.

The inventors have confirmed by experiments that a desired stiffness of the bearing can be ensured by employing the following configurations as specific examples of the shapes of the groove 16d, the groove 16e and the path 16f. In a case where the cross-sectional shape of the groove 16d and the groove 16e is a concave arc or a rectangle, the opening width of the grooves is in the range of 0.2 to 0.8 mm, the depth of the grooves is in the range of 0.1 to 0.8 mm, the number of each of the grooves is one, the diameter of the shape of the path 16f is in the range of 0.3 to 2.0 mm, and the viscosity of the lubricating fluid 28 at 25° C. is in the range of 5 to 30 cst.

In the rotary device 100 of FIG. 2 according to the embodiment, the fluid is the lubricating fluid 28 in liquid state. The lubricating fluid 28 fills a lubricating fluid holding portion including the spaces constituting the first pump portion 55, the first radial narrow gap 56, the first thrust narrow gap 63, the first circulation path 51, the second pump portion 57, the second radial narrow gap 58, the second thrust narrow gap 64 and the second circulation path 52, and the space between the housing 14 and the flange 26. The lubricating fluid holding portion typically has an open end exposed to the air. However, the lubricating fluid 28 may leak from the open end. Therefore, the rotary device 100 may further include a capillary seal portion TS being connected with at least one of the first circulation path 51 and the second circulation path 52 and having an air-liquid interface between the fluid and the air in a middle portion thereof.

It may be conceived to arrange the capillary seal portion TS on the outer side in the axial direction (upper side in FIG. 2) of the first thrust narrow gap 63, for example. In this case, however, the rotary device 100 may become thicker. Accordingly, the capillary seal portion TS may be arranged to surround the sleeve 16, that is, at a position overlapping with the sleeve 16 in the axial direction. As a result, it is possible to prevent the rotary device 100 from being thicker.

In the rotary device 100 of FIG. 2 according to the embodiment, the capillary seal portion TS is constituted by an outer circumferential surface 14e of the housing 14 and an inner circumferential surface 20e of the first cylindrical portion 20b of the hub 20. The outer circumferential surface 14e is inclined in a manner that the diameter becomes smaller from the upper surface side toward the lower surface side. Similarly, the inner circumferential surface 20e opposed to the outer circumferential surface 14e is inclined in a manner that the diameter becomes smaller from the upper surface side toward the lower surface side. Such a structure allows the outer circumferential surface 14e and the inner circumferential surface 20e to form the capillary seal portion TS that is constituted by the space therebetween and that becomes wider from the upper surface side toward the lower surface side. The filling amount of the lubricating fluid 28 is set so that the interface between the lubricating fluid 28 and the air (air-liquid interface) is positioned in a middle portion of the capillary seal portion TS. Accordingly, the lubricating fluid 28 is sealed by the capillary seal portion TS due to the capillary action. As a result, the lubricating fluid 28 is prevented from leaking out.

In addition, the capillary seal portion TS is structured such that the inner circumferential surface 20e that is an outer inclined surface has a diameter that becomes smaller from the upper surface side toward the lower surface side as described above. Thus, in the capillary seal portion TS, the rotation of the rotor R causes a centrifugal force to act on the lubricating fluid 28 to move the lubricating fluid 28 inward (upward). Accordingly, the lubricating fluid 28 is more securely prevented from leaking out.

In addition, in the embodiment, a coated portion 20g coated with an oil repellent agent may be provided along the circumferential direction on the inner circumferential surface 20e on the side of the open end of the capillary seal portion TS so as to prevent shortage of the lubricating fluid 28. Further, a coated portion 14f coated with an oil repellent agent may be provided on the outer circumferential surface 14e along the circumferential direction. The oil repellent agent may be a solution of Teflon (registered trademark) resin in a solvent. The coated portion 20g and the coated portion 14f are constituted by Teflon (registered trademark) films formed by causing the solvent to evaporate. In this case, it is possible to repel drops of the lubricating fluid 28 splashed from the air-liquid interface of the lubricating fluid 28 by the Teflon (registered trademark) films of the coated portion 20g and the coated portion 14f to bring the splashed drops back into the reservoir region of the lubricating fluid 28. As a result, it is possible to easily prevent reduction of the lubricating fluid 28. The positions of the coated portion 20g and the coated portion 14f may be appropriately determined at any positions on the open end side with respect to the air-liquid interface. As described above, it is possible to reduce the load in driving the rotary device 100 such as a disk drive device by improving leakage preventing performance of the lubricating fluid 28 of the rotary device 100 such as a disk drive device. Accordingly, the reliability of maintaining the stiffness of the bearing can be improved while avoiding excessive drive current consumption.

It may be conceived to form the shaft and the sleeve using different materials. However, if there is a large difference in the coefficient of linear expansion between the shaft and the sleeve, the space between the outer cylindrical surface 22c and the inner cylindrical surface 16b varies greatly due to temperature change. If the space becomes larger, the radial stiffness of the bearing lowers. As a result, rotation failures will occur more frequently. On the other hand, if the space becomes smaller, losses due to the load on the bearing may be increased, which may increase power for driving the rotary device. Thus, the shaft and the sleeve may be formed of materials that have substantially equal coefficients of linear expansion. As a result, it is possible to suppress variation in the space between the outer cylindrical surface 22c and the inner cylindrical surface 16b due to temperature change.

Next, the operation of the rotary device 100 structured as described above will be described. Three-phase drive currents are supplied to the coil 18 so as to rotate the recording disk 120. The flow of the driving currents through the coil 18 causes drive magnetic fluxes to be generated along the nine salient poles. The drive magnetic fluxes apply a torque to the cylindrical magnet 24. As a result, the hub 20 and the recording disk 120 fitted thereto are rotated. At the same time, the magnetic head 124 moves back and forth within the swinging range above the recording disk 120 by swinging the swing arm 122 by the voice coil motor 118. The magnetic head 124 converts magnetic data recorded on the recording disk 120 into an electric signal and transmits the signal to a control board (not shown). The magnetic head 124 also writes data transmitted from the control board in the form of electric signal on the recording disk 120 as magnetic data.

In the embodiment of FIG. 2, it has been described that the first end portion 16a and the second end portion 16c are formed integrally with the sleeve 16. However, the first end portion 16a and the second end portion 16c may be formed as separate members from the sleeve 16 and then assembled with the sleeve 16. This structure can produce similar advantageous effects.

In the embodiment of FIG. 2, it has been described that two flows of the lubricating fluid 28 in opposite directions are generated by two pump portions having substantially the same shape. However, a structure in which a different number of pump portions or pump portions having different shapes are used can produce similar advantageous effects. For example, a structure in which two or more pump portions having different shapes are provided or a structure in which only one pump portion is provided can produce similar advantageous effects.

In the embodiment of FIG. 2, it has been described that the pumping grooves are formed to have a linear shape and arranged in stripes. However, even if the pumping grooves are formed in a curved shape or in a shape bent at middle portions and arranged in stripes, similar advantageous effects can be obtained.

In the embodiment of FIG. 2, it has been described that the surfaces defining the radial narrow gaps and the thrust narrow gaps are smoothed uniformly. However, even if the surfaces are formed to include concaves and convexes, similar advantageous effects can be obtained.

In the embodiment of FIG. 2, it has been described that the sleeve 16 and the housing 14 are formed as separate members. However, even if the sleeve 16 and the housing 14 are formed integrally, similar advantageous effects can be obtained.

In the embodiment of FIG. 2, it has been described that the flange 26 and the shaft 22 are formed as separate members. However, even if the flange 26 and the shaft 22 are formed integrally, similar advantageous effects can be obtained.

In the embodiment of FIG. 2, it has been described that the fluid is a lubricating fluid in liquid state. However, even if the fluid is in the form of gas such as air, similar advantageous effects can be obtained.

In the embodiment of FIG. 2, it has been described that the first circulation path 51 and the second circulation path 52 are formed to include the grooves formed in the outer circumferential surface of the sleeve 16. However, even if the first circulation path 51 and the second circulation path 52 are formed to include grooves formed in the inner circumferential surface of the housing 14, similar advantageous effects can be obtained.

Further, in the embodiment, the rotary device (HDD) 100 has been described as an example of a rotary device according to an aspect of the invention. However, the rotary device according to an aspect of the invention only needs to include: a sleeve having an inner cylindrical surface, a first end portion at an outer position in an axial direction of the inner cylindrical surface, and a second end portion that is an end portion opposite to the first end portion; a shaft that has at least a part thereof accommodated in the inner cylindrical surface and that is rotatable relative to the inner cylindrical surface; a fluid present at least in a space between the shaft and the sleeve; a first pump portion formed in a middle portion in the axial direction of the inner cylindrical surface and configured to generate a first flow of the fluid in a direction toward the first end portion by the relative rotation of the shaft and the sleeve; a first radial narrow gap formed at a region of the inner cylindrical surface on a side of the first end portion with respect to the first pump portion; and a first circulation path connected to the first end portion of the sleeve and communicated with the first pump portion.

Therefore, the rotary device according to an aspect of the invention is not limited to such an HDD, but may be any other disk drive device that rotates other disks such as a DVD, or any other rotor drive device for rotating a rotor other than a disk.

A disk drive motor (such as a brushless motor) that is a component of such a drive device, and further a bearing unit that is a component of the motor can be a rotary device according to an aspect of the invention.

In addition, a device for recording and/or reproduction to/from an optical disk or a magnetic disk that includes the disk drive device as described above as a component thereof can be a rotary device according to an aspect of the invention.

As described above, the rotary device according to an aspect of the invention may include all of or some of members for reading/writing data (such as a recording disk 120, a swing arm 122, a magnetic head 124, and a voice coil motor 118). The rotary device according to an aspect of the invention may be a device only including a part for rotationally driving a rotor such as a disk (a recording disk, for example).

The invention is not limited to the above-described embodiment, but various modifications can be made thereto including design modifications based on the knowledge of those skilled in the art. The structures shown in the drawings are explanatory only. Thus, modifications can be made thereto as appropriate and similar advantageous effects can be obtained as long as similar functions can be achieved.

While the invention has been illustrated and described in detail, the foregoing description is in all aspects illustrative and not restrictive. It is therefore understood that numerous modifications and variations can be devised without departing from the spirit and scope of the invention.

What is claimed is:

1. A rotary device comprising:
a sleeve having an inner cylindrical surface, a first end portion at an outer position in an axial direction of the inner cylindrical surface, and a second end portion that is an end portion opposite to the first end portion;
a shaft that has at least a part thereof accommodated in the inner cylindrical surface and that is rotatable relative to the inner cylindrical surface;
a fluid present at least in a space between the shaft and the sleeve;
a first pump portion formed in a middle portion in the axial direction of the inner cylindrical surface and configured to generate a first flow of the fluid in a direction toward the first end portion by the relative rotation of the shaft and the sleeve;
a first radial narrow gap formed at a region of the inner cylindrical surface on a side of the first end portion with respect to the first pump portion; and
a first circulation path connected to the first end portion of the sleeve and communicated with the first pump portion.

2. The rotary device according to claim 1, wherein a region of an outer cylindrical surface of the shaft and a region of the inner cylindrical surface forming the first radial narrow gap are smoothed.

3. The rotary device according to claim 1, wherein a first thrust narrow gap is formed at a region outside of the inner cylindrical surface in a radial direction of the first end portion.

4. The rotary device according to claim 1, wherein the first pump portion includes first pumping grooves arranged in stripes and formed in at least one of an outer cylindrical surface of the shaft and the inner cylindrical surface.

5. The rotary device according to claim 3, further comprising a first thrust member extending outward in a radial direction of the shaft and substantially fixed to the shaft, wherein
the first thrust narrow gap is formed in a region where the first thrust member and the first end portion are opposed to each other along the axial direction.

6. The rotary device according to claim 5, wherein a region of the first end portion and a region of the first thrust member forming the first thrust narrow gap are smoothed.

7. The rotary device according to claim 1, further comprising a housing accommodating at least a part of the sleeve.

8. The rotary device according to claim 7, wherein at least a part of the first circulation path is formed between the sleeve and the housing.

9. The rotary device according to claim 1, further comprising:
a second pump portion formed in a middle portion in the axial direction of the inner cylindrical surface and configured to generate a second flow of the fluid in a direction toward the second end portion by the relative rotation of the shaft and the sleeve;
a second radial narrow gap formed at a region of the inner cylindrical surface on a side of the second end portion with respect to the second pump portion; and
a second circulation path connected to the second end portion of the sleeve and communicated with the second pump portion.

10. The rotary device according to claim 7, further comprising:
a second pump portion formed in a middle portion in the axial direction of the inner cylindrical surface and configured to generate a second flow of the fluid in a direction toward the second end portion by the relative rotation of the shaft and the sleeve;
a second radial narrow gap formed at a region of the inner cylindrical surface on a side of the second end portion with respect to the second pump portion; and
a second circulation path connected to the second end portion of the sleeve and communicated with the second pump portion, wherein
at least a part of the second circulation path is formed between the sleeve and the housing.

11. The rotary device according to claim 9, wherein a region of an outer cylindrical surface of the shaft and a region of the inner cylindrical surface forming the second radial narrow gap are smoothed.

12. The rotary device according to claim 9, wherein a second thrust narrow gap is formed at a region outside of the inner cylindrical surface in a radial direction of the second end portion.

13. The rotary device according to claim 9, wherein the second pump portion includes second pumping grooves arranged in stripes and formed in at least one of an outer cylindrical surface of the shaft and the inner cylindrical surface.

14. The rotary device according to claim 10, further comprising a second thrust member extending outward in a radial direction of the shaft and substantially fixed to the shaft, wherein
the second thrust narrow gap is formed in a region where the second thrust member and the second end portion are opposed to each other along the axial direction.

15. The rotary device according to claim 14, wherein a region of the second end portion and a region of the second thrust member forming the second thrust narrow gap are smoothed.

16. The rotary device according to claim 14, wherein a thrust accommodating region is formed between a bottom portion of the housing and the second end portion, and the second thrust member is arranged in the thrust accommodating region.

17. The rotary device according to claim 9, wherein a part of the first circulation path is connected to a part of the second circulation path.

18. The rotary device according to claim 9, wherein the fluid is a liquid, and
the rotary device further comprises a capillary seal portion connected to at least one of the first circulation path and the second circulation path and having an air-liquid interface between the fluid and air at a middle portion thereof.

19. The rotary device according to claim 18, wherein the capillary seal portion surrounds the sleeve and is formed at a position overlapping with the sleeve in the axial direction.

20. The rotary device according to claim 1, wherein the shaft and the sleeve are formed of materials having substantially equal coefficients of linear expansion.
